(19) United States
(12) Patent Application Publication
(10) Pub. No.: US 2010/0138807 A1
(43) Pub. Date: Jun. 3, 2010

(54) Method and System for Benefits Calculator for Information Technology Projects

(76) Inventor: Pamela A. M. Bogdan, Neptune, NJ (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/327,008

(22) Filed: Dec. 3, 2008

(51) Int. Cl. G06F 9/44

(52) U.S. Cl. 717/101

(57) ABSTRACT

Described herein are systems and methods for providing a generic benefits calculator for IT projects. An exemplary method includes receiving user input corresponding to parameters of an information technology project, retrieving information corresponding to the information technology project, calculating, based on the parameters, updated information corresponding to the information technology project, and creating a summary of the updated information corresponding to the information technology project. An exemplary system includes an input module receiving user input corresponding to parameters of an information technology project, a core input module receiving information corresponding to the information technology project, a core analysis module calculating, based on the parameters, updated information corresponding to the information technology project, and a user output module creating a summary of the updated information corresponding to the information technology project.

### BACKGROUND

Information technology (“IT”) may be defined as the study, design, development, implementation, support or management of computer-based information systems, particularly software applications and computer hardware. IT deals with the use of electronic computers and computer software for application development, wherein these applications are able to convert, store, protect, process, transmit, and securely retrieve information. An IT service may accomplish a variety of tasks that range from installing applications to designing complex computer networks and information databases. Furthermore, these IT services may also provide services such as data management, networking, engineering computer hardware, database and software design, as well as the management and administration of entire systems. Thus, an IT solution may generally describe any technology service that helps to produce, manipulate, store, communicate, and/or disseminate information.

An IT project may be described as a finite endeavor, having specific start and completion dates undertaken, to create a unique product or service that brings about beneficial change or added value. This finite characteristic of IT projects sets projects apart from standard business operations, which may be described as permanent or semi-permanent functional work to continuously produce the same product or service. In practice, the management and financial analysis of IT services and business operations systems is typically found to be quite different, and as such requires the development of distinct benefit analysis skills and the adoption of separate management philosophies.

In many cases for an IT project, estimating the overall financial benefit is one of the key challenges. Most of the personnel involved planning the IT solution are not equipped or tooled with the ability to efficiently and accurately create the business case level summaries. Furthermore, due to the lack of common tooling and knowledge, there is a widespread range of projected output. Accordingly, there is no uniformity or consistency in these outputs.

### SUMMARY OF THE INVENTION

The present invention is generally related to systems and methods for providing a generic benefits calculator for IT projects. One exemplary embodiment is related to a method including receiving user input corresponding to parameters of an information technology project, retrieving information corresponding to the information technology project, calculating, based on the parameters, updated information corresponding to the information technology project, and creating a summary of the updated information corresponding to the information technology project.

A further exemplary embodiment is related to a system including an input module receiving user input corresponding to parameters of an information technology project, a core input module receiving information corresponding to the information technology project, a core analysis module calculating, based on the parameters, updated information corresponding to the information technology project, and a user output module creating a summary of the updated information corresponding to the information technology project.

A further exemplary embodiment is related to a computer readable storage medium storing a set of instructions executable by a processor, wherein the set of instructions being operable to receive user input corresponding to parameters of an information technology project, retrieve information corresponding to the information technology project, calculate, based on the parameters, updated information corresponding to the information technology project, and create a summary of the updated information corresponding to the information technology project.

### BRIEF DESCRIPTION OF THE DRAWINGS

FIG. 1 shows an exemplary system for providing a generic benefits calculator for IT projects according to an exemplary embodiment of the present invention.

FIG. 2 shows an exemplary system for integrating the generic benefits calculator with a variety of task components and respective personnel according to an exemplary embodiment of the present invention

FIG. 3 shows an exemplary method for providing a generic benefits calculator for IT projects according to an exemplary embodiment of the present invention.

FIG. 4A shows an exemplary method for providing user input data to a generic benefits calculator for IT projects according to an exemplary embodiment of the present invention.

FIG. 4B shows an exemplary table for receiving flow and sub-flow impact input data to a generic benefits calculator for IT projects according to an exemplary embodiment of the present invention.

FIG. 4C shows an exemplary table for receiving per unit benefits input data to a generic benefits calculator for IT projects according to an exemplary embodiment of the present invention.

FIG. 5A shows an exemplary method for calculating benefits for IT projects according to an exemplary embodiment of the present invention.

FIG. 5B shows an exemplary table for summarizing and reporting per unit benefits input data to a generic benefits calculator for IT projects according to an exemplary embodiment of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods for providing a generic benefits calculator for IT projects. The exemplary calculator may serve as a productivity enhancement tool for personnel working in the front-end of an IT service provider. Specifically, the exemplary embodiments are related to systems and methods allowing for quick and efficient analysis and summary of the benefit attributes. For example, depending on the type of IT project and the type of business processes, these benefit attributes may be applicable to improvements such as a reduction in cycle time for IT service delivery, as well as productivity enhancement.

It is noted that in the following examples, a factory setting is used to show the impact of an exemplary information technology project such as the number of factory orders impacted, a percentage of factory orders impacted, the factory processes impacted, etc. However, those skilled in the art will understand that the systems and methods described herein may be applied to any setting in which an information technology project may impact cost, productivity, etc. For example, an information technology project applied to a call center may impact the number of calls the center is able to handle at various times, the number of operators on duty, the number of calls any one operator can handle, etc. In another example, an information technology project applied to an e-commerce server farm location may impact a number of orders that the server farm can process, the amount of time it takes to complete an order or display items for sale, etc. Thus, as can be seen from these examples, the exemplary systems and methods may be used in any type of environment.

According to the exemplary embodiments of the present invention, the benefits calculator may be built with the ability to serve as a generic tool that is specific to a particular situation based on input provided by a user, as well as core input data. This exemplary benefits calculator may convert a process engineering view of the benefits quickly and easily into a business case view of the benefits. In other words, the benefits calculator may consolidate and universally distribute any collective knowledge for translation of operational benefit into financial benefits.

As will be described in greater detail below, the exemplary systems and methods provided by the benefits calculator may allow for simple and efficient determination of a variety of financial benefits, such as, for example, for IT service delivery projects. Since the majority of IT personal may lack the knowledge and common tooling to perform such determinations, there is typically a widespread range of output in this area. In order to address these issues, the benefits calculator described herein may allow a business or organization to achieve uniformity, consistency, as well as efficiency. It should be noted that while the exemplary embodiments of the benefits calculator may be implemented within a spreadsheet software application (e.g., Microsoft Excel), there is no particular software limitation of the calculator that requires any specific underlying software program.

As discussed above, the exemplary embodiments of the present invention will be described with reference to a benefits calculator for a front-end IT business or organization. However, those skilled in the art will understand that the present invention may be implemented in any type of business operation, whether it is in the field of IT service delivery or within any other service of IT. For example, the exemplary systems and methods described herein may be applied to any other development or investment planning, with specific back-end logic. As will be described in greater detail below, regardless of the software program utilized, and regardless of which process a business uses, the ease and flexibility of the exemplary generic benefits calculator may allow end-users to efficiently translate any operational benefit into financial benefits.

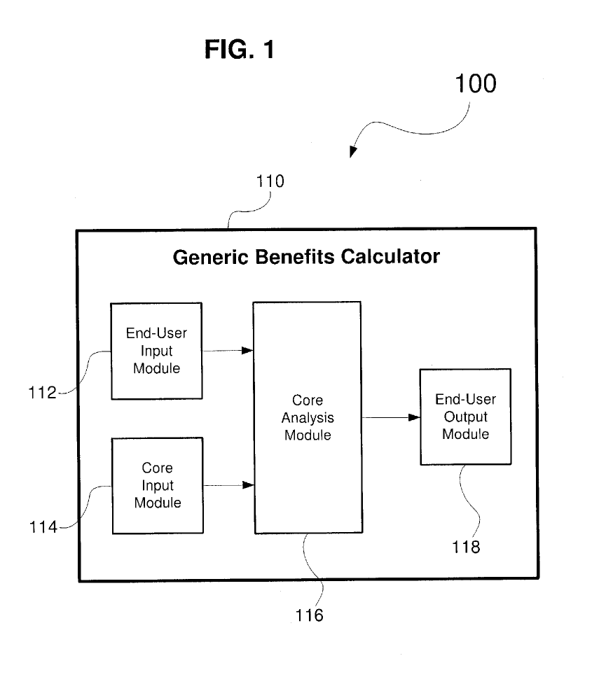

FIG. 1 shows an exemplary system 100 for providing a generic benefits calculator 110 for IT projects according to an exemplary embodiment of the present invention. The generic benefits calculator 110 may include a plurality of modules, such as an end-user input module 112, a core input module 114, a core analysis module 116, and an end-user output module 118. It should be noted that the details of the data collected and/or produced by the various modules of the benefits calculator 110 may be viewable to the end-user, while remaining protected.

According to the exemplary embodiments of the system 100, the generic benefits calculator 110 may provide end-users with various improvements in IT project planning. As described above, an exemplary implementation of the benefits calculator 110 may include assessing the financial and operational benefits of an IT project. Since the functions performed by the benefits calculator 110 may be repeatable processes, such as having key algorithms and core data be continuously collected and updated for all users of any project, the benefits calculator 110 may save time when evaluating operational and financial benefits. Furthermore, the benefits calculator 110 may provide improved cross-project decision-making by allowing for uniform analysis of multiple projects to be viewed in a side-by-side manner. As will be described in greater detail below, the benefits calculator 110 may also enhance the identification of potential benefits. Specifically, all categories of benefits may be requested for assessment each time the benefits calculator 110 is implemented within a project.

The ease-of-use and simplification in the benefits calculation allow for improved confidence in a project approval process. Specifically, each end-user may provide input from their respective domain of expertise. Official forecasting and IT scheduling information may be combined in a back-end computation by the benefits calculator 110 in order to generate a simple executive level summary of the financial benefits of a given IT project. For example, the benefits calculator 110 may provide financial translations based on operational characteristics such as, but not limited to, process time reduction, manual step elimination, impacted services, percentage of volume, etc. Thus, the user input provided to the benefits calculator 110 may be flexible enough to allow for the creation of numerous hypothetical scenarios (e.g., “what-if” analysis), using variation in the operational characteristics.

The end-user input module 112 of the exemplary benefits calculator 110 may provide an interface for receiving data specific to the project. The interface of the end-user input module 112 may be implemented through a spreadsheet software application, such as MS Excel. Accordingly, the end-user input module 112 may allow for manual input of data related to factory services and/or factory orders. In the example where the IT project supports service delivery, the exemplary data may include, for example, a selection of impacted services/products (e.g., “factory orders” types) by the project, specific types of available IT services (e.g., various speeds of IT services), percentage of yearly forecast for each impacted factory order types. However, as described above this data is only exemplary and may depend on the location impacted by the IT project (e.g., factory, office, call center, server farm, laboratory, etc.). In this example, the end-user input module 112 may include quantified “factory process” benefits, as well as high-level IT project cost estimations and scheduling. As will be described in greater detail below, the end-user input module 112 may also receive further user input, such as, for example, cycle time benefits delivery profiles, productivity benefits delivery profiles, and estimates on the cost for the IT project (e.g., high order of magnitude (“HOM”) estimates).

The core input module 114 of the exemplary benefits calculator 110 may provide an interface for receiving data specific to official forecast and IT scheduling, as well as for monetary translations (e.g., translations of resulting statistical information into dollar values). It should further be noted that the monetary translation is not limited to dollar translations, as the core input module 114 may translate information into any form of currency. Similar to the interface of the end-user input module 112, the interface for the core input module 114 may also be implemented through a spreadsheet software application, such as MS Excel. Accordingly, the core input module 114 may allow for the input of data related to official factory order volume and IT schedules. Official factory order volume for a given time frame or time series (e.g., yearly, monthly, quarterly, etc.) may include the number of order for a particular service or product provided by the IT project during that time series.

The core analysis module 116 of the exemplary benefits calculator 110 may combine the official forecast and IT schedules provided by the core input module 114 with the project-specific data provided by the end-user input module 112 using core analysis algorithms. These core analysis algorithms may include a plurality of financial translation values for converting a business view of an IT project into a financial view of the project. It should be noted that the analysis algorithms may be tailored to any type of business model, and may receive continuous updates from support personnel. Therefore, the core analysis module 116 may take the inputted business process benefits for any IT project and create a time sequence business benefits view. Accordingly, this business process benefits view may be combined with IT release schedules and official forecast/unit pricing in order to translate the time sequence business benefits into a financial view.

The end-user output module 118 of the exemplary benefits calculator 110 may take the financial view computed by core analysis module 116 in order to create an executive level summary of the overall cost and benefits of the IT project. This summary may include benefit information such as revenue acceleration and productivity gain, as well as the IT cost using HOM sizing. Furthermore, the benefits and costs for each IT project occurring for a given year may be summarized on a benefits calculations sheet.

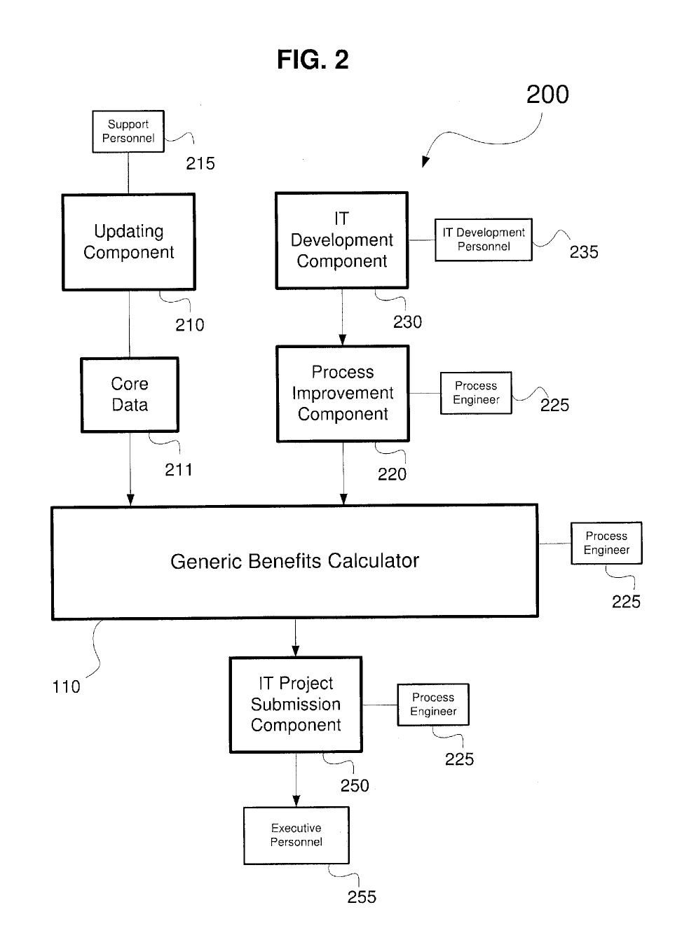

FIG. 2 shows an exemplary system 200 for integrating the generic benefits calculator 110 with a variety of task components 210-250 and respective personnel according to an exemplary embodiment of the present invention. The task components may include an updating component 210, a process improvement component 220, an IT development component 230, a cost/benefit summary component 240, and an IT project submission component 250. Each of these components, combined with the benefits calculator 110, may be involved in the both the collection of IT project data, as well as the analysis and reporting of the benefit attributes of the project. These benefit attributes may be specific to the business and may include, for example, improvements in cycle time, productivity enhancements, etc.

The generic benefits calculator 110 may be in communication with the updating component 210, wherein the updating component 210 may provide periodic updates to the core data 211, as well as the core analysis algorithms. Furthermore, the updating component 210 may be maintained by support personnel 215, such as tool support and developers. Specifically, the core data 211 may be modified when there are changes in the business. Accordingly, the processes and calculation performed by the algorithms may be customized or otherwise adjusted to allow the benefits calculator 110 to accommodate any type of IT project, or to simply maintain accuracy in the computations.

The process improvement component 220 allows for a process engineer 225 to create an IT project-based solution for a business problem. Specifically, the process engineer 225 may identify the business process and/or factory flow that may be impacted by the IT project, as well as selecting the percentage that each type is impacted, an expected date of change, and the benefits. Specifically, the process engineer 225 may reference an official view of the core data 211 and filter the data in order to accommodate the specific IT project. As described above, the factory order volume may include, for example, the number of orders for a particular service or product.

The IT development component 230 may allow for IT development personnel 235 to create development sizing and release proposals for the IT project. This may include, for example, identifying the IT project, the cost of the project, and the expected date in which the project is to be implemented.

The IT project submission component 250 may allow for the process engineer 225 to submit the business case level financial summary of the IT project to personnel at the executive level. Therefore, benefits associated with the IT project, both in productivity improvement and in cycle time reduction, may be quickly and easily viewable at the executive level. Accordingly, the financial summary from IT project submission component 250 may be provided to executive personnel 255.

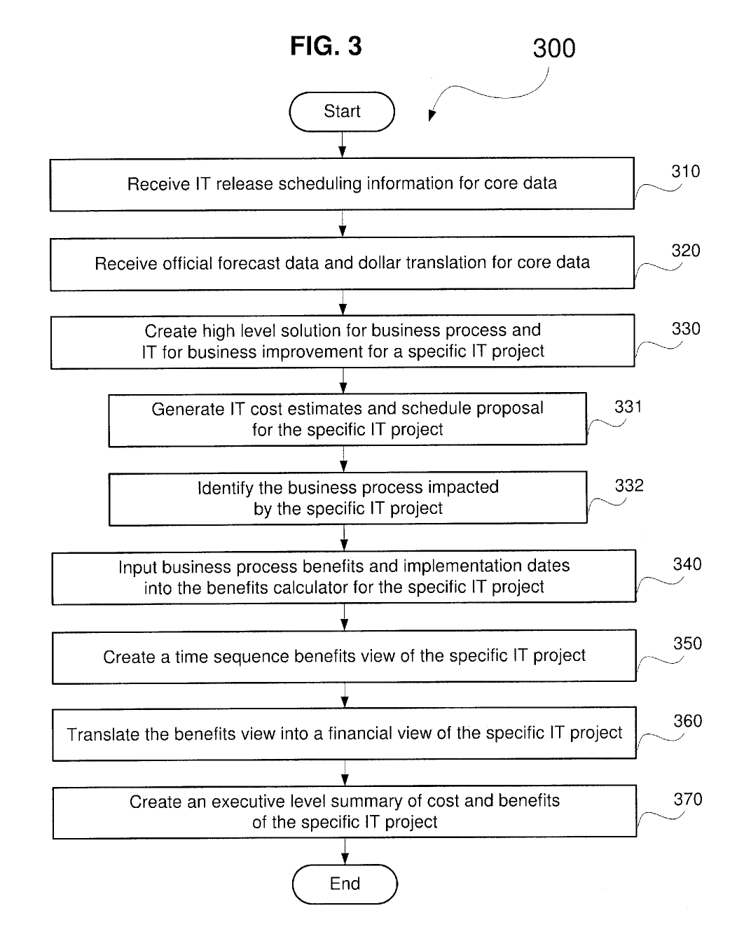

FIG. 3 shows an exemplary method 300 for providing a generic benefits calculator for IT projects according to an exemplary embodiment of the present invention. It should be noted that method 300 will be discussed with reference to the generic benefits calculator 110 and components of the system 100 of FIG. 1.

Beginning with step 310, the method 300 may receive IT release scheduling information related to an IT release. An exemplary IT release may include a plurality of IT projects. Accordingly, this information may be provided to the benefits calculator 110 through the core input module 114 of FIG. 1.

In step 320, the method 300 may receive official forecast data and unit pricing data related to the factory service and/or product via support input. Specifically, this information may be provided to the benefits calculator 110 through the core input module 114 of FIG. 1. According to the exemplary embodiments of the present invention, the forecast data may include forecasted multi-year flow rates.

In step 330, the method may create a high level solution for business process and IT for business improvement. The step 330 may include additional sub-step such as sub-steps 331-332. Furthermore, this information from steps 330-332 may be provided to the benefits calculator 110 through the end-user input module 112 of FIG. 1

In sub-step 331, the method 300 may generate IT cost estimates and IT project schedule proposal related to the IT project. These estimates may include both a preliminary high-level estimate and a preliminary low-level estimate of costs. Furthermore, the IT project schedule proposal may include a proposed delivery release date. As will be described below, the IT project schedule information for each IT project may be then provided to the benefits calculator 110 in step 360.

In sub-step 332, the method 300 may identify the factory services, products, and/or factory flows impacted by the IT project, as well as the percentage that each type is impacted. Specifically, an end-user may choose the products/services that will be impacted by the IT project and the percentage of yearly forecast for each impacted factory products/services and then further breakout to sub-flow processes of a multi-flow business process. These factory services/products may be specific to the business enterprise undertaking the IT project. As described above, an example of this data may list a selection of the services/products (e.g., “factory orders” types) impacted by the project, the specific types of available IT services (e.g., various speeds of IT services), percentages of yearly forecast for each impacted factory order types, etc. As will be described below, the resulting forecast information for each products/services may be then provided to the benefits calculator 110 in step 360.

In step 340, the method 300 may input both business process benefit attributes and one or more implementation dates into the exemplary benefits calculator 110. Specifically, this information may be provided to the benefits calculator 110 through the end-user input module 112 of FIG. 1. For example, each of these benefit attributes may be specific to the business process, and may include such benefits as cycle time reduction (e.g., in days), productivity improvements (e.g., in minutes), etc. Cycle time reduction may account for how quickly a factory flow can be accomplished, while productivity improvements may account for the decrease in manual effort (e.g., “touch time”) from personnel. According to a specific example, the end-user may input both cycle time and touch time reduction amounts, as well as the initial impact date for the IT project. In other words, the end-user may quantify a specific implementation date into the benefits calculator 110.

In step 350, the method 300 may create, via the benefits calculator 110, a time sequence benefits view of the IT project. Specifically, this information may be processed by the core analysis module 116 within the benefits calculator 110 of FIG. 1. Accordingly, the core analysis module 116 may combine the business process benefits of step 350 with the resulting forecast information and the IT scheduling information of steps 340 and 320, respectively. For example, the benefits calculator 110 may build a per-unit monthly benefit profile and multiple each unit by volumes. These volumes may be specific to the type of business enterprise, as well as the type of IT project.

In step 360, the method 300 may translate, via the benefits calculator 110, the time sequence benefits view into a financial view of the IT project. Specifically, this information may be translated by the core analysis module 116 within the benefits calculator 110 of FIG. 1. Accordingly, the core analysis module 116 may apply both the IT release schedules of step 310 with the official forecast and unit pricing of step 320 to core analysis algorithms of the core analysis module 116. For example, the benefits calculator 110 may multiply the monthly total benefits view from step 360 by one or more financial translation values.

In step 370, the method 300 may create, via the benefits calculator 110, an executive level summary of the costs and benefits of the IT project. Specifically, the end-user output module 118 of FIG. 1 may provide the end-user with this executive level summary. The summary may display single value summaries of the benefits as well as the summary details of benefits for the IT project by period (e.g., yearly). The summary may breakdown the monthly revenue adjustments for each product or service, as well as adjustments based on the benefits attributes (e.g., adjustments in productivity and cycle time for these products or services, etc.). Thus, the end-user may be provided with a customized and detailed description of the time and cost benefits provided from each of the IT projects.

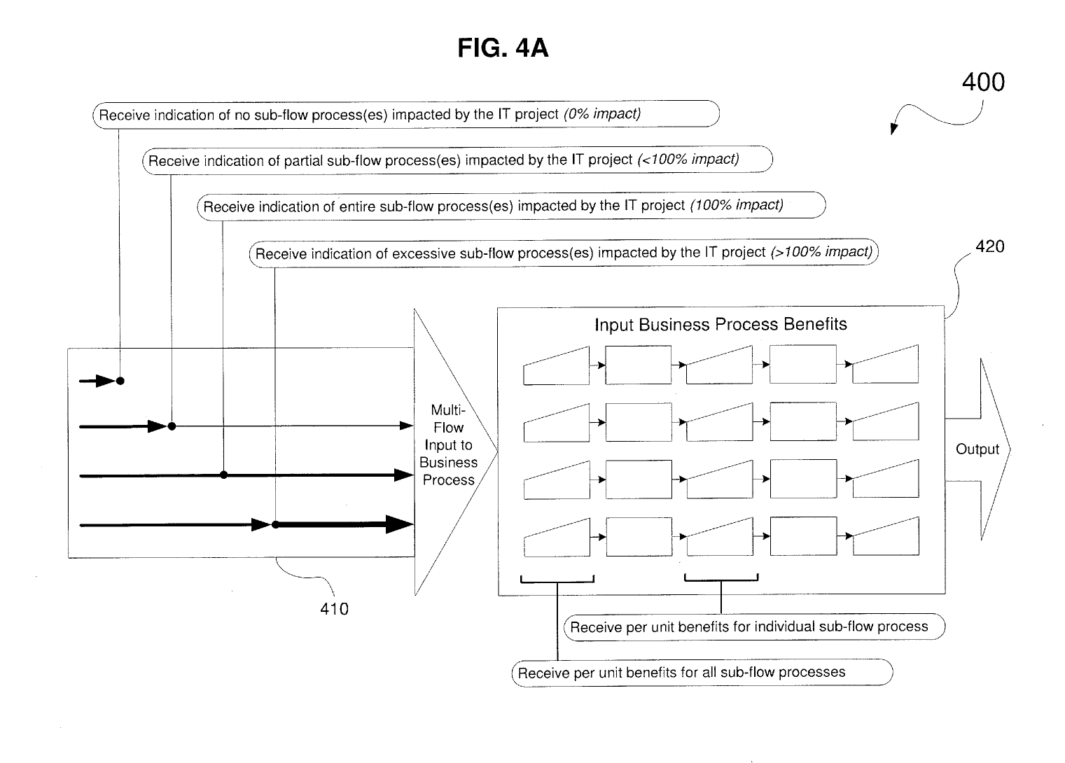

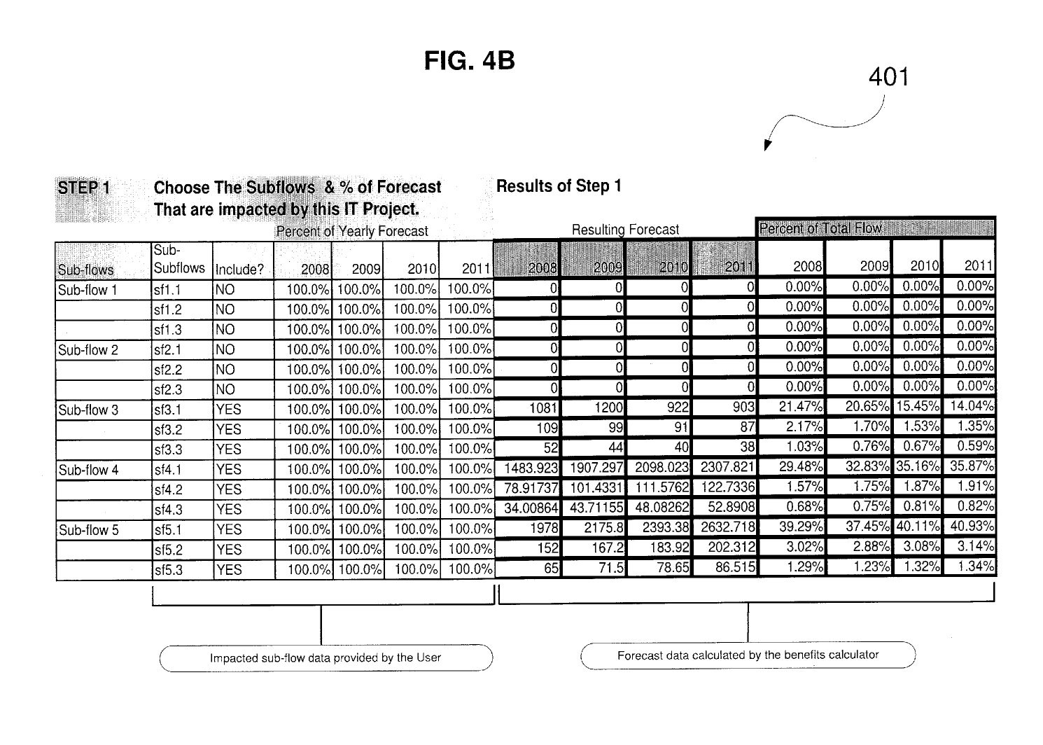

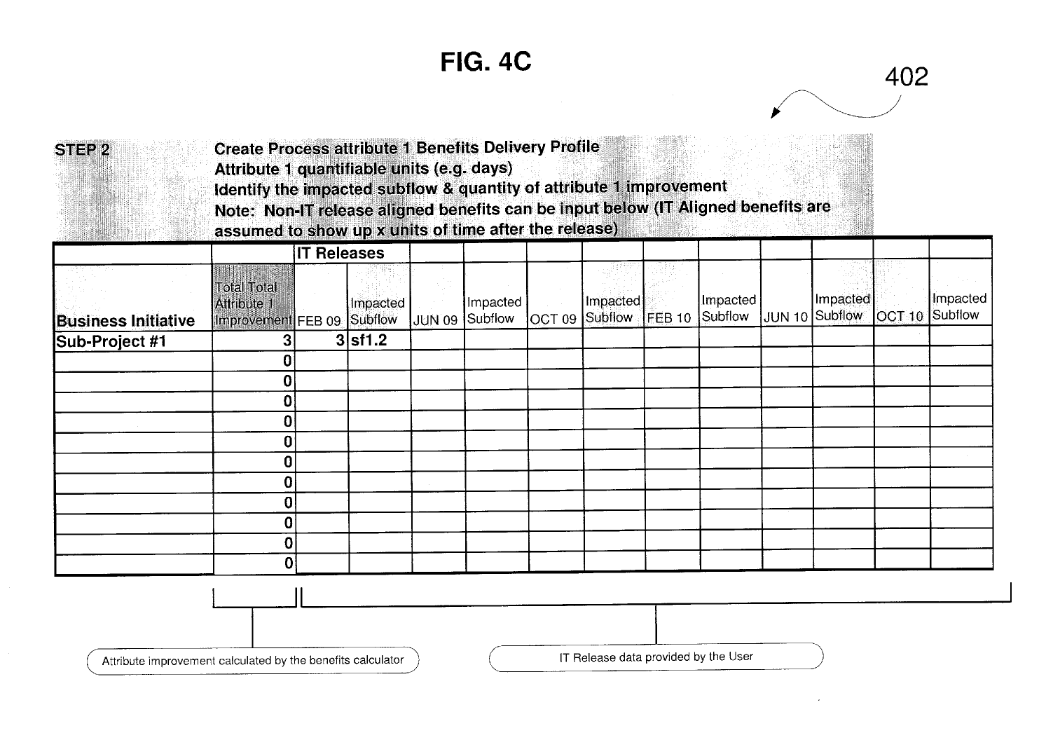

FIG. 4A shows an exemplary method 400 for providing user input data to the generic benefits calculator 110 for IT projects according to an exemplary embodiment of the present invention. In step 410, the benefits calculator 110 may receive indications of which sub-processes, or “sub-flow processes”, within a multi-flow business process are affected by the IT project. Specifically, the step 410 may allow the user to indicate whether or not a specific type of sub-flow process will be impacted by the IT project. In addition, the user may further provide a degree of impact (e.g., how much of an impact) for each of the sub-flow processes. As described above, the user may input a selection of impacted factory services/products (e.g., “factory orders” types) by the project, as well as percentage of yearly forecast for each impacted factory order types.

For example, according one embodiments of the exemplary method 400, the benefits calculator 110 may simply receive a “yes” or a “no” for each of the sub-flow processes within the multi-flow process. However, according to a further embodiment of the method 400, the user may also indicate a percentage of impact for each of the sub-flow processes. Therefore, the benefits calculator 110 may receive varying degrees of impact for each of the sub-flow processes, such as for example, no impact (0% impact), partial impact (<100% impact), complete or entire impact (100% impact), and excessive impact (>100% impact). Excessive impact may be due to an increase in volume resulting from process improvements. Thus, the benefit calculator 110 may be customized to summarize and report on the relevant flows that are impacted within a business process.

In step 420, the benefits calculator 110 may receive an input of business process benefits for the IT project. Specifically, the step 420 may allow the user to quantify per-unit benefits for individual sub-flow processes, as well as to quantify per-unit benefits for all of the sub-flow processes. For example, these benefits may include cycle time reduction (e.g., in days) and productivity, or touch time, improvements (e.g., in minutes). Thus, for each sub-flow process, the end-user may input both cycle time and touch time reduction amounts, as well as the initial impact date (e.g., an initial implementation date) for the IT project.

FIG. 4B shows an exemplary table 401 for receiving flow and sub-flow impact input data to the generic benefits calculator 110 for IT projects according to an exemplary embodiment of the present invention. Specifically, the table 401 may serve an exemplary input screen for the end-user input module 112 of FIG. 1. As illustrated in table 401, the user may input each of the sub-flow processes (e.g., sub-flows 1-5). The user may indicate whether the sub-flow processes are impacted by the IT project (e.g., YES/NO). The user may further indicate the percentage of yearly forecast for each of the impacted sub-flows (e.g., for each year 2008-2011). These indications may also be made for sub-sub-flows within the multi-flow business process. As sub-sub-flow may be defined as any flow processes within a sub-flow process. Accordingly, any number of sub-flow iteration may be detailed for each flow of the business process. Based on the input provided by the user for each of the sub-flow processes 1-5, the benefits calculator 110 may calculate a resulting forecast for each sub-flow, as well as a percentage of the total business process, or total flow, for the sub-flows. It should be noted that while exemplary table 410 provides a yearly forecast of the impacted sub-flow processes, the exemplary method 400 may be applied for any periodic time series (e.g., monthly, quarterly, yearly, etc.)

FIG. 4C shows an exemplary table 402 for receiving per unit benefits input data to the generic benefits calculator 110 for IT projects according to an exemplary embodiment of the present invention. As described above, the user (e.g., a process engineer 225) may create various benefits delivery profiles based on specific benefit attributes. For example, these benefit delivery profiles may include a cycle time benefits delivery profile to identify an access type impacted by the project, an IT release date, and a cycle time reduction (e.g., in a number of days), a productivity benefits delivery profile to identify an access type impacted by the project, an IT release date, and a productivity improvement (e.g., in a number of minutes), etc.

Accordingly, the user may provide the benefits calculator 110 with IT release data. Specifically, the user may identify the impacted sub-flow processes as well as a quantity of an improvement in an attribute (e.g., “Attribute 1”). Specifically, for a particular business initiative (e.g., “Sub-Project #1”), the benefits calculator 110 may receive an indication for per unit benefits (e.g., days) of an impacted sub-flow process (e.g., sf1.2) during a periodic basis (e.g., monthly). Therefore, the benefits calculator 110 may calculate the quantity of attribute improvements for the business initiative. According to the example illustrated in the table 402, the impacted sub-sub-flow process “sf1.2” may result a productivity improvement of 3 days during the month of February 2009. Similar to the table 401, the table 401 is not limited to one specific time series and may calculate benefits deliver over any periodic time series (e.g., monthly, quarterly, yearly, etc.)

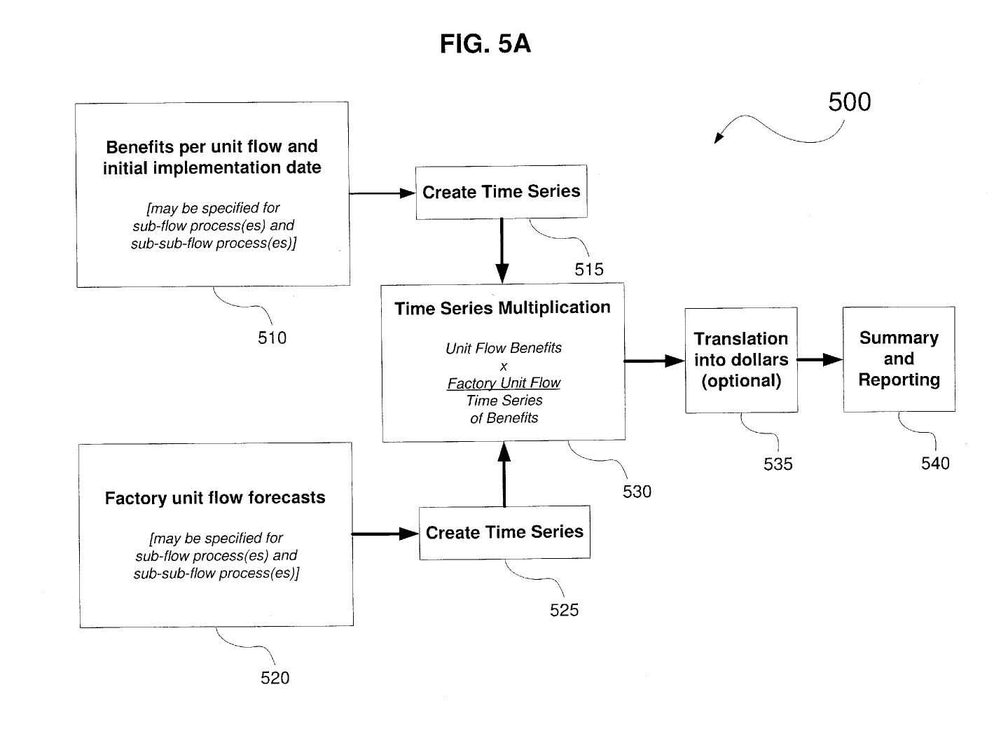

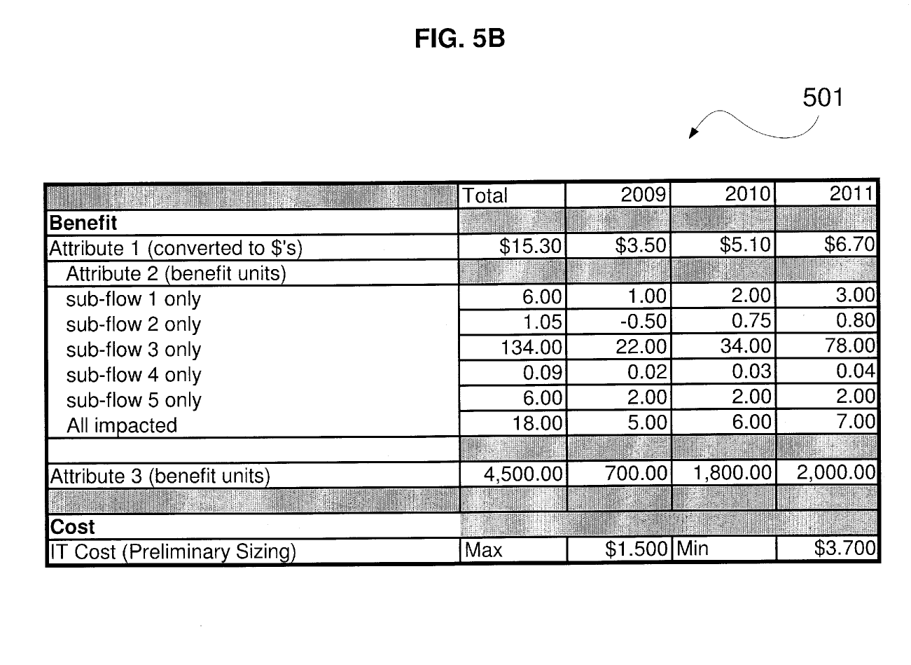

FIG. 5A shows an exemplary method 500 for calculating benefits for IT projects according to an exemplary embodiment of the present invention. Specifically, the exemplary method 500 may demonstrate a calculation performed by the benefits calculator 110 for benefits calculations.

In step 510, the benefits calculator 110 may record unit flow benefits. Specifically, the calculator 110 may receive the benefit per unit flow and the initial implementation dates from a user, as specified for each of the impacted sub-flow processes and sub-sub-flow processes. In step 515, the calculator 110 may create a time series summary of the unit flow benefit attributes.

In step 520, the benefits calculator 110 may record factory unit flows pertinent to this project. Specifically, the calculator 110 may receive the factory unit flow forecasts adjustments from a user, as specified for each of the impacted sub-flow processes and sub-sub-flow processes. In step 525, the calculator 110 may create a time series summary of the factory unit flow data and unit pricing data related to the IT project via end-user input.

In step 530, the method 500 may calculate the time series of benefits. Specifically, the calculator 110 may multiply the unit flow benefits time series of step 510 (e.g., attribute benefits, cost benefits, etc.) by the factory flow time series of step 520 in order to determine an incremental benefits time series. According to one exemplary embodiment, the unit flow benefit may be expressed, for example, in terms of cycle time reduction (e.g., in days) and productivity improvements (e.g., in minutes). As described above, these benefits may be specific to the IT project, and as such, are not limited to the exemplary improvements such as cycle time reduction or productivity improvements.

In step 535, the method 500 may perform a monetary translation of the benefits time series. For example, the incremental unit flow benefit may be translated in to dollar amounts. As noted above, the monetary translation is not limited to dollar translations, as the monetary translations may translate information into any form of currency. It should be further noted that the step 535 is an optional step, specific to the type of business process and type of IT project. Accordingly, the step 535 may be omitted when a monetary translation is not necessary or not applicable. Finally, in step 540, the method 500 may provide a benefits summary for reporting purposes.

FIG. 5B shows an exemplary table 501 for summarizing and reporting benefits and costs according to an exemplary embodiment of the present invention. For example, the time series of benefits for a particular IT project may include multiple benefit attributes such as Attribute 1, expressed in cost, and Attributes 2 and 3, expressed in benefit units. As illustrated in table 501, these exemplary benefits may be reported over a yearly time series (e.g., from 2009 through 2011), as well as a total benefit calculation for the reported periods. Therefore, the impact of each of the attributes and any of the sub-flow processes may be easily viewable in an executive level summary. Thus, the benefits calculator 110 is able to quickly and efficiently analyze the user data and generate a business case view of the unit flow benefits of this particular IT project.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
receiving user input corresponding to parameters of an information technology project;
retrieving information corresponding to the information technology project;
calculating, based on the parameters, updated information corresponding to the information technology project; and
creating a summary of the updated information corresponding to the information technology project.

2. The method of claim 1, further comprising:
displaying the summary of the updated information corresponding to the information technology project.

3. The method of claim 1, wherein the information is one of a financial forecast of the information technology project and a schedule of the information technology project.

4. The method of claim 1, wherein the user input is received via a spreadsheet application.

5. The method of claim 1, wherein the calculating includes converting the parameters and information into financial information based on financial translation values.

6. The method of claim 1, wherein the summary includes at least one of an overall cost of the information technology project, a revenue acceleration based on the information technology project, a productivity gain based on the information technology project, a cycle time, and a mean time to repair.

7. The method of claim 1, wherein an algorithm used for calculating the updated information is updateable by a user.

8. The method of claim 1, further comprising:
receiving a selection of one of a product and a service impacted by the information technology project, wherein the updated information relates to the selected one of the product and service.

9. A system, comprising:
an input module receiving user input corresponding to parameters of an information technology project;
a core input module receiving information corresponding to the information technology project;
a core analysis module calculating, based on the parameters, updated information corresponding to the information technology project; and
a user output module creating a summary of the updated information corresponding to the information technology project.

10. The system of claim 9, wherein the user output module further displays the summary of the updated information corresponding to the information technology project.

11. The system of claim 9, wherein the information is one of a financial forecast of the information technology project and a schedule of the information technology project.

12. The system of claim 9, wherein the input module includes a spreadsheet application for receiving the user input.

13. The system of claim 9, wherein the core analysis module converts the parameters and information into financial information based on financial translation values.

14. The system of claim 9, wherein the summary includes at least one of an overall cost of the information technology project, a revenue acceleration based on the information technology project, a productivity gain based on the information technology project, a cycle time, and a mean time to repair.

15. The system of claim 9, wherein the core analysis module includes a user interface for a user to update an algorithm used for calculating the updated information.

16. The system of claim 9, wherein the user input includes a selection of one of a product and a service impacted by the information technology project, wherein the updated information relates to the selected one of the product and service.

17. A computer readable storage medium storing a set of instructions executable by a processor, the set of instructions being operable to:
receive user input corresponding to parameters of an information technology project;
retrieve information corresponding to the information technology project;
calculate, based on the parameters, updated information corresponding to the information technology project; and
create a summary of the updated information corresponding to the information technology project.

18. The set of instructions of claim 17, further being operable to:
display the summary of the updated information corresponding to the information technology project.

19. The set of instructions of claim 17, wherein the information is one of a financial forecast of the information technology project and a schedule of the information technology project.

20. The set of instructions of claim 17, wherein the user input is received via a spreadsheet application.
